(19) United States
(12) Patent Application Publication
(10) Pub. No.: US 2026/0015095 A1
(43) Pub. Date: Jan. 15, 2026

(54) AIRCRAFT PROPULSION SYSTEM AND METHOD

(71) Applicant: GKN AEROSPACE SERVICES LIMITED, Solihull (GB)

(72) Inventors: Joseph Stonham, Solihull (GB); Simon Taylor, Solihull (GB); Stephen Harrison, Solihull (GB)

(21) Appl. No.: 18/881,732

(22) PCT Filed: Jul. 5, 2023
(86) PCT No.: PCT/GB2023/051770

§ 371 Date: Jan. 7, 2025

(30) Foreign Application Priority Data
Jul. 8, 2022 (GB) 2210071.3

(51) Int. Cl. B64D 27/355; B64D 41/00; F02C 6/00; H01M 8/04111; H01M 8/10

(52) U.S. Cl. CPC B64D 27/355; B64D 41/00; F02C 6/00; H01M 8/04111; B64D 2041/005; H01M 2008/1095; H01M 2250/20

(57) ABSTRACT

The present invention relates to an aircraft propulsion system (100) comprising: a fuel cell arrangement comprising at least one fuel cell (110); an air source (130) for providing air to the fuel cell arrangement; a compressor arrangement comprising a first compressor (120) in fluid communication with the air source and a fuel cell of the fuel cell arrangement; and, a turbine arrangement comprising a first turbine (124) mechanically coupled to the first compressor, wherein the first turbine is in fluid communication with the at least one fuel cell (110), the system being arranged so that, in use, air from the air source (130) flows in turn to the first compressor (120), the fuel cell arrangement and the first turbine (124).

### TECHNICAL FIELD

The present invention is concerned with aircraft propulsion systems and power systems. In particular, to aircraft propulsion arrangements which are able to provide a controllably variable level of power and, therefore, thrust at different pressure levels. Different levels of thrust may be delivered to an aircraft based on the specific stage of flight as the stage of flight relates to the pressure experienced by the thrust generating portions of the aircraft. This invention is also concerned with auxiliary power units (APUs) and secondary power unit (SPU) for aircraft. Pressure differences can cause complications in the delivery of power or thrust within an aircraft.

Aircraft gas turbine systems typically provide in the region of 50% of their ground static propulsive power (power required to provide thrust force) at top of climb conditions but around 100% during take off. As such, there is a difference between the power that is to be delivered by an aircraft propulsion system during different stages of flight of an aircraft.

Typically, gas turbines operate well in this aspect as both the thrust lapse of a gas turbine engine and therefore the ratio of thrust to power of take off and top of climb are generally well suited to the inherent properties of a gas turbine. Further, the high specific power afforded by larger and fewer gas turbines leads to little competition from other propulsion architectures due to economic considerations. Therefore, modern systems favour the gas turbine for aircraft propulsion arrangements.

Drawbacks to gas turbine engines include environmental demands, however to date no serious alternatives to the gas turbine engine exist that are able to provide varying thrust in the same manner at similar economic considerations. As such, the gas turbine is the preferred and de facto option for use in aircraft.

Although hydrogen fuels and hydrogen synthetic fuels (synfuels) are occasionally used in aircraft, this is not regularly the case in larger aircraft and not at all in passenger aircraft. This is by virtue of the specific power that can be provided by gas turbines in comparison to that provided by hydrogen systems. Gas turbines can achieve around 5 to 8 kW/kg for a typical system, while hydrogen fuel cell systems can achieve around 1 kW/kg. As such, hydrogen is a reasonable, and an environmentally conscious, choice for smaller aircraft but all but entirely prevented from use in commercial, larger systems.

Fuel cells using hydrogen are under investigation, e.g. Polymer Exchange Membrane (PEM), and recent work has indicated that the specific power value for such systems may optimistically reach 2 kW/kg in the next 5 to 10 years. Some other work has noted that there may be an absolute maximum value of around 1.8 kW/kg. As such, it appears that these systems could not be feasible for use in commercial, passenger aircraft without significant economic drawbacks.

Fuel cells can be operated in an overrated function to provide around 25% greater output for a small amount of time. This figure is higher at the start of life for fuel cells but degrades towards the end of life. Due to the mechanics of overrating, damage may be done to the fuel cell if overrated for long periods and will anyhow lead to degradation of life of the fuel cell. Even using this method, however, clearly the significant difference between take off thrust and top of climb thrust cannot be accounted for in a fuel cell propulsion system.

Aircraft therefore typically require around twice the power during takeoff and climb compared to cruise. This take off and climb phase can last around 5-20 minutes compared to the more than 1 (and up to more than 12) hours of flight time. The total duration of max power within a flight is approximately 5 to 30 mins. The duration from takeoff to cruise altitude transition is of the order of <300 s for peak power. The remaining peak power is a risk contingency for go arounds (during pre-landing phases) and deviation to another airport. The current state of the art arrangements contain such remaining peak power for around three go arounds and one deviation to another airport.

To preserve hydrogen fuel typically fuel cell systems are designed to consume hydrogen and to lead to a waste of air (and therefore of oxygen) of up to 50%. Although this may benefit low quality heat dissipation because of the reaction into the air, it requires greater compression power (nearly double) and therefore increases the parasitic losses where compression is between 15-45% of the fuel cell power and the most significant parasitic power loss.

Considerations regarding the cathode size of the stack takes into account the needed rate of oxygen reaction, whereby the O2 is approximately 20% of atmospheric air.

Oxygen may be used in a fuel cell however, oxygen is 8 times the mass of hydrogen and is needed in a ratio of 4:1 (for H2O). As such, carrying oxygen onboard the aircraft is not seen as effective for flight.

Two stage compression has been used for achieving the high pressure ratio required for operating fuel cells at altitude, however when operating a fuel cell at low altitude and at high altitude where low and high pressure ratios are required respectively, it may not be efficient to operate in a fixed configuration. Therefore, consideration regarding use of a fuel cell across a range of altitude conditions and delivery of the requisite airflow to achieve suitable power for different stages of flight is required.

Therefore, there are developments that can be made in this field and advantages that can be obtained from these developments. The inventors of an invention described herein have however created an alternative propulsion arrangement which has a wide range of previously unavailable advantages as described herein.

### SUMMARY OF THE INVENTION

Aspects of the invention are set out in the accompanying claims.

Viewed from first aspect there is provided an aircraft propulsion system comprising: a fuel cell arrangement comprising at least one fuel cell; an air source for providing air to the fuel cell arrangement; a compressor arrangement comprising a first compressor in fluid communication with the air source and a fuel cell of the fuel cell arrangement; and, a turbine arrangement comprising a first turbine mechanically coupled to the first compressor, wherein the first turbine is in fluid communication with the at least one fuel cell, the system being arranged so that, in use, air from the air source flows in turn to the first compressor, the fuel cell arrangement and the first turbine.

The invention described herein allows a user great control over the propulsive output of the system so that the user can tailor the system for the conditions in which the system is used. This in turn provides gains in efficiencies and therefore a more economical flight.

A compressor may be used to provide greater concentrations of specific fuels such as oxygen to the fuel cell. In this way, the system can account for low oxygen environments and still provide efficient energy production to the propulsion system.

Viewed from another aspect there is provided a method of generating propulsion for an aircraft, comprising: passing air from an air source to a first compressor; compressing the air; passing the compressed air to a fuel cell arrangement comprising at least one fuel cell for generating energy; passing the fuel cell output air to a first turbine for operating the turbine; and, operating the compressor and turbine, wherein the compressor and turbine are mechanically coupled.

Viewed from yet another aspect there is provided an auxiliary power unit APU for use in an aircraft comprising: a fuel cell arrangement comprising at least one fuel cell; an air source for providing air to the fuel cell arrangement; a compressor arrangement comprising a first compressor in fluid communication with the air source and a fuel cell of the fuel cell arrangement; and, a turbine arrangement comprising a first turbine mechanically coupled to the first compressor, wherein the first turbine is in fluid communication with the at least one fuel cell, the system being arranged so that, in use, air from the air source flows in turn to the first compressor, the fuel cell arrangement and the first turbine, and wherein the air source is selectable from a combination of ambient, environmental control system exhaust or oxygen.

### BRIEF DESCRIPTION OF THE DRAWINGS

One or more embodiments of the invention will now be described, by way of example only, and with reference to the following figures in which:

FIG. 1 shows a schematic of a fuel cell propulsion system including stacks and turbo compressor;

FIGS. 2a to 9 shows schematics of fuel cell propulsion systems with a switched multi-stage compressor and turbine arrangement;

FIG. 10 shows a schematic of a fuel cell propulsion system including a bypass valve connected to the fuel cell system; and

FIG. 11 shows a schematic of a fuel cell propulsion system with a switched 2-stage compressor and turbine arrangement.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”. The invention is further described with reference to the following examples. It will be appreciated that the invention as claimed is not intended to be limited in any way by these examples. It will also be recognised that the invention covers not only individual embodiments but also combination of the embodiments described herein.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the spirit and scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

### DETAILED DESCRIPTION

An invention described herein relates to generating propulsion for an aircraft and power systems. A particular engine system for an aircraft may involve a fuel cell, at least one compressor and at least one turbine. The generation of propulsion is dependent on factors than can be affected by altitude. As such, the aircraft propulsion systems herein are arranged to account for the differing power requirements during different phases of flight as a result of the differing pressures at different altitudes. Additional power may be provided during take off/climb and then not be provided during cruising. The additional power for take off and climb is therefore required at a higher pressure when at ground and at a lower pressure nearing the top of the climb phase.

Advantageously, fuel cell stacks can tolerate some variation in operating pressure (around 1 to 3 Bar). To utilise ambient air at altitude, the air delivery system may have a higher pressure ratio. The consumption of air by a fuel cell stack is proportionate to the power produced, based on the stoichiometry of the stack. As such, the air delivery system can vary the mass flow of air to the fuel cell stack accordingly to the power requirements.

An invention described herein relates to power generation through an Auxiliary Power Unit (APU), which can be designed so as to provide a number of necessary functions for an aircraft. The APU may be small and provide only aircraft electrical power (typically secondary or emergency) or be sized larger so as to, alternatively or additionally, provide propulsion. The APU may be connected to or contain an accessory shaft arranged to connect the APU to a generator.

The present invention provides a number of inventive strategies that enable compression and compressed fuels to be used more efficiently in fuel cell propulsion systems.

Oxygen sources that may provide oxygen for use in a fuel cell propulsion system, for example in an aircraft arrangement, include the environment control system (ECS), obtaining oxygen (O2) via enrichment of ambient air or use of a dedicated (or otherwise) oxygen source. The oxygen source may be a liquid oxygen source (LOx). Advantageously the liquid oxygen is less space intensive than oxygen in a gaseous phase, therefore there are capacity advantages associated with use of LOx in any of the systems described herein. Specifically the volumetric density of LOx is superior to oxygen in gaseous form.

Aircraft often carry on-board oxygen and this is a byproduct of the electrolysis process in the production of hydrogen (H2) from water. Many current aircraft carry on-board oxygen in bottles that can be used in case of cabin depressurisation as might occur from a blown out window or the like. The amount stored is suitable to cover the period until a descent to a safe altitude can be achieved. While passengers use drop down oxygen masks, the crew for example may use portable oxygen bottles. As such, current aircraft often have an oxygen generator or, more commonly, gaseous oxygen tanks onboard.

Additional power may be provided from a fuel cell arrangement through the use of the provision of compressed fuels into the fuel cells. In particular, in compressed oxygen and hydrogen that are subsequently provided to the fuel cell, fuel cell stack or fuel cell array.

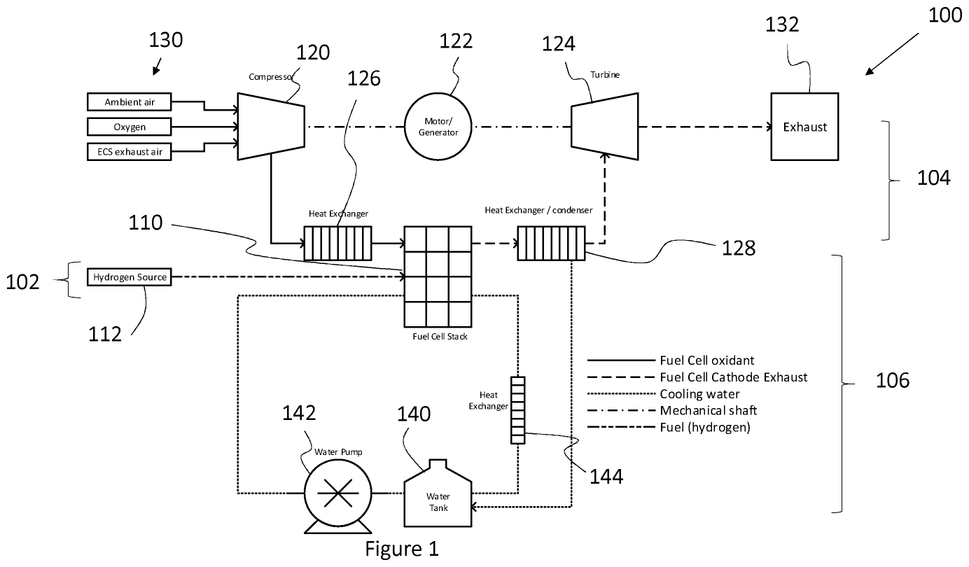

Referring now to FIG. 1, there is shown a propulsion system 100 comprising a fuel cell stack 110. The fuel cell stack 110 is connected to a H2 supply 112 via a H2 supply line. This hydrogen portion is labelled by portion 102.

While a hydrogen supply will be used throughout the examples shown herein, alternative suitable fuels such as hydrocarbons, ethanol, methanol, ammonia, or the like, could be used with the proposed propulsion system. The hydrogen supply may comprise 100% hydrogen or a lower percentage with percentages of carbon monoxide (CO), carbon dioxide (CO₂), nitrogen dioxide (NO₂), and/or hydrogen sulphide (H₂S) in the supply. The hydrogen supply (or hydrogen source) may provide liquid or gaseous hydrogen. Liquid hydrogen may be used in cooling functions prior to use in the fuel cell in a gaseous form.

The propulsion system 100 has a compressor 120, a motor/generator 122 and a turbine 124. The compressor 120 is connected to a heat exchanger 126 and the turbine 124 is connected to another heat exchanger/condenser 128. The compressor 120 is connected to the ECS exhaust air supply, oxygen supply or ambient air supply 130. The compressor 120 may be a turbo compressor of a single stage centrifugal type and needs to provide the complete range of pressure ratios for all operation conditions from a pressure ratio of approximately 3 to approximately 9. The system may be an electrically driven compressor 120 and can use a turbine 124 for energy harvesting from the cathode (hot air exhaust) 132. The compressor 120 may be part of a compressor arrangement, which may comprise a number of compressors located within the system 100. The compressors of the compressor arrangement need not be directly linked but can be. The turbine 124 may be part of a turbine arrangement, which may comprise a number of turbines located within the system 100. The turbines of the turbine arrangement need not be directly linked but can be.

The compressors and turbines shown herein may be single entry, single stage centrifugal types which may also be known as radial compressors and turbine. Alternatively, the compressors and turbines shown herein may be double entry centrifugal compressors or axial compressors and turbines.

The ECS exhaust air supply, oxygen supply or ambient air supply 130 is shown as providing air to the compressor 120. The compressor 120 may use any one of the supplies or a combination from the supplies. In this way, the air supplied to the compressor 120 may be enriched by oxygen concentrators or by provision of a greater percentage of oxygen from the oxygen supply. Further, oxygen enrichment of any of the supplies may happen before or after the oxygen reaches the air supply 130 in the process. The turbine 124 is connected to the cathode exhaust 132. This air/exhaust portion is labelled by portion 104. Element 130 is referred to as an ECS exhaust air supply but may also be an external (ambient) air supply or the like. The main function of element 130 is to provide air (whether oxygen enriched in some way or not) for use in the fuel cell stack 110, via the single compressor 120 of the system 100.

The two heat exchangers 126, 128 are connected to the fuel cell stack 110. Heat exchanger 126 is connected to compressor 120 and fuel cell stack 110 and cools air exiting from the compressor 120. This heat exchanger 120 may be optional depending on both the temperature limits of the fuel cell stack 110 and the temperature of the air after compression by the compressor 120. The fuel cell stack 110 is connected to a water tank 140 via a water pump 142 and a heat exchanger 144. The water tank 140 is connected to the heat exchanger/condenser 128. This water portion is labelled by portion 106.

The examples shown herein are of a water cooled fuel cell stack system. The examples shown would also operate well in air-cooled or evaporative cooled arrangements or where another coolant medium is used. The examples shown have been simplified to emphasise the most inventive elements of the present system. However, these are merely examples. Such examples may omit in-depth details relating to less prevalent elements in the system, such as optional recirculation systems that might be used to recirculate hydrogen. Other omissions include humidifiers that can be used on the cathode air supply. Therefore, while not explicitly shown, such features can be included in the present arrangement. Furthermore, the present arrangements may be used with evaporative cooled fuel cell stacks.

Indeed, the condensing heat exchanger 128 may be optional for the high power phase with no condense water extracted. Instead, the moist air may be sent overboard (“spilled”) or stored in an intermediate container until it can be sent overboard. In this manner, the pressure loss inherent in the use of the condense heat exchanger 128 would not be included in the arrangement, which leads to a higher performance system (in the form of more power). To compensate for this spilling overboard of moist air, a slightly larger water tank would be required.

In the arrangement shown in FIG. 1, the propulsion system 100 uses ECS air with oxygen concentrators. There are a number of advantages that stem from this arrangement: The oxygen concentrators (oxygen separators) may be used to produce a higher percentage of O2 in the air in the portion 104 than in the cabin or than in external ambient air. Use of a higher percentage of O2 for a period will enable the fuel cell to operate at a net higher power level during that period. In contrast, systems without an oxygen concentrator use oxygen as contained in ambient air. The result is that many current fuel cell systems waste air and consume H2 to its fullest extent. This is necessary with ambient air as the approximately 21% 02 (as in air) will become depleted and could potentially starve the fuel cell. This is not the case with an oxygen system. O2 in the reactant ratio is 4 times heavier than the H2 and, as such it makes more sense that, if waste is to occur, the H2 is wasted. This is further justified as substantially more H2 is stored than O2 and, as such, the change in mass at system level (tank mass specifically) is lower. Additionally, and beneficially, in the high power case for a cryogenically cooled system this arrangement allows for more available heat dissipation in the liquid hydrogen.

The air source requires less compression than an external ambient air (which, at altitude, can be low). Our estimates show that the compression is around 3 times rather than 9 times which would be required for ambient air. This is because the air source may come from the cabin air, which has already been pressurised, and because the air can be enriched with oxygen. Enrichment with oxygen results in less air being required, and accordingly less compression is required.

With reference to the three supplies 130 shown, there may be benefits to using the exhaust air from the ECS without additional oxygen supplied. The exhaust ECS air has a lower oxygen concentration and so, when used in a fuel cell stack 110, the stack 110 would produce less power. However the fuel cell system as a whole may still be more efficient as the parasitic power demand from the compressor may be lower than a conventional system using ambient air. This benefit also increases with altitude, providing a particular benefit for the present system.

Additional advantages can be gained from the lower temperature air in the air source when compared to compressed ambient air. In the arrangement wherein heat exchanger 126 is omitted, there is no pressure loss associated with the inclusion of the heat exchanger 126. Accordingly, the lower air temperature on the cathode side means that the fuel cell stack 110 is able to dissipate more heat into the air before an equivalent stack temperature is reached (equivalent temperature to an arrangement including heat exchanger 126). In this way, the omission of the heat exchanger 126 may be beneficial as enabling operation of the fuel cell stack 110 at a higher power.

The oxygen concentrators can be used so as to increase the O2 ratio within the air supplied in the portion 104 or the oxygen concentrators may be used to supply pure oxygen to the system 100. As previously mentioned, use of higher proportion of O2 in the air supply 130 to the fuel cell stack 110 enables a greater power output from the fuel cell stack 110 as there is less non-reactive air (nitrogen etc) passing through the fuel cell stack 110. Alternatively, a smaller fuel cell stack can be provided which provides the same output power (as a result of the greater per size power output of the present fuel cell stack 110 arrangement).

In the event that liquid oxygen is used from an oxygen supply (such as a tank or the like), the specific heat of vaporization and specific heat capacity of the oxygen can be used to cool elements of the propulsion system 100. Cooling of electrical elements leads to gains in efficiencies die to lack of e.g. eddy currents etc. Furthermore, use of pure oxygen in the system 100 can enable use of a smaller fuel cell area and therefore smaller and lighter stack 110. This leads to efficiency benefits as a result of the mass of the stack that needs to be carried, for example, by an aircraft in use. The lower mass the stack, the less fuel required to account for that mass in comparison to a heavier system.

Liquid oxygen enables an even lower inlet temperature of the oxidant which in turn enables the fuel cell. stack 110 to operate at potentially higher heat dissipation and therefore power.

Further potential advantages include that, as the only gas content is oxygen this oxygen could be consumed entirely. For an air system, typically only 50% of the oxygen may be consumed as the system has to ensure that the fuel cell stack has sufficient O2, as such an overprovision of O2 is preferred. The current system 100 has a benefit in ensuring less oxygen waste as well as reducing the pressure loss (including back pressure) at the outlet of the stack 110.

In the example shown in FIG. 1, the fuel cell stack 110 needs to operate well in both the above-described cases as such a more primary advantage relates to increased stack power (prior to accounting for parasitic losses, ie turbocompressor, pumps etc.) and net power, rather than a slightly more secondary advantage regarding resizing the stack 110.

By re-using the ECS air via the supply 130, the system 100 has no requirement for an external air intake to bring in air from the surrounding environment. As such, there are aerodynamic drag benefits associated with the omission of an external air intake element. This drag benefit translates to a benefit associated with the energy demand on the system 100 as a whole; it can be understood that the system 100 would need to provide more thrust to accommodate an element that was likely to provide additional drag. By removing the need for this element, the system 100 is more efficient.

As mentioned, this system has a fixed configured which may not be efficient for providing power across a wide range of altitudes and therefore pressures.

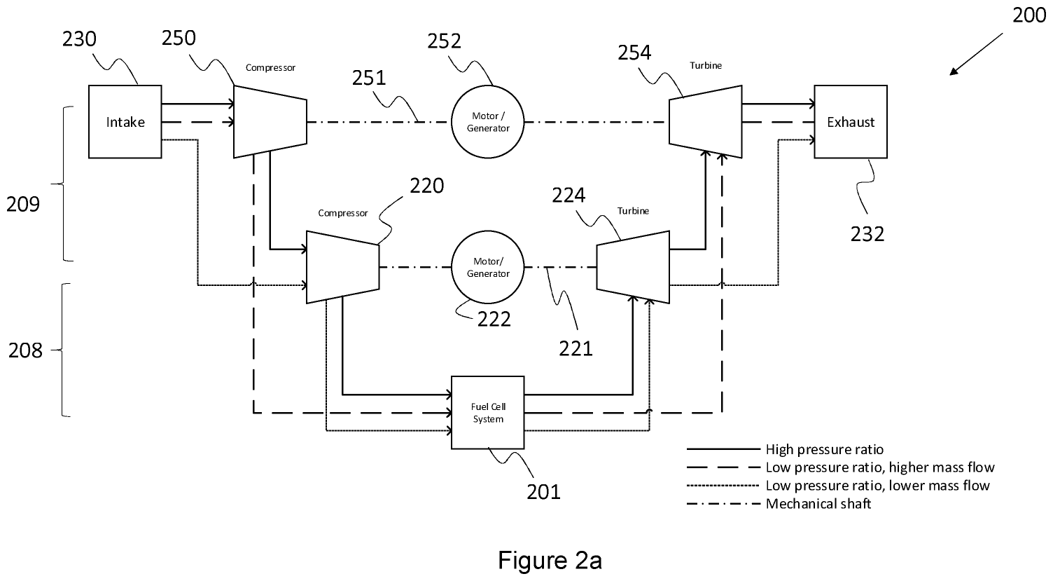

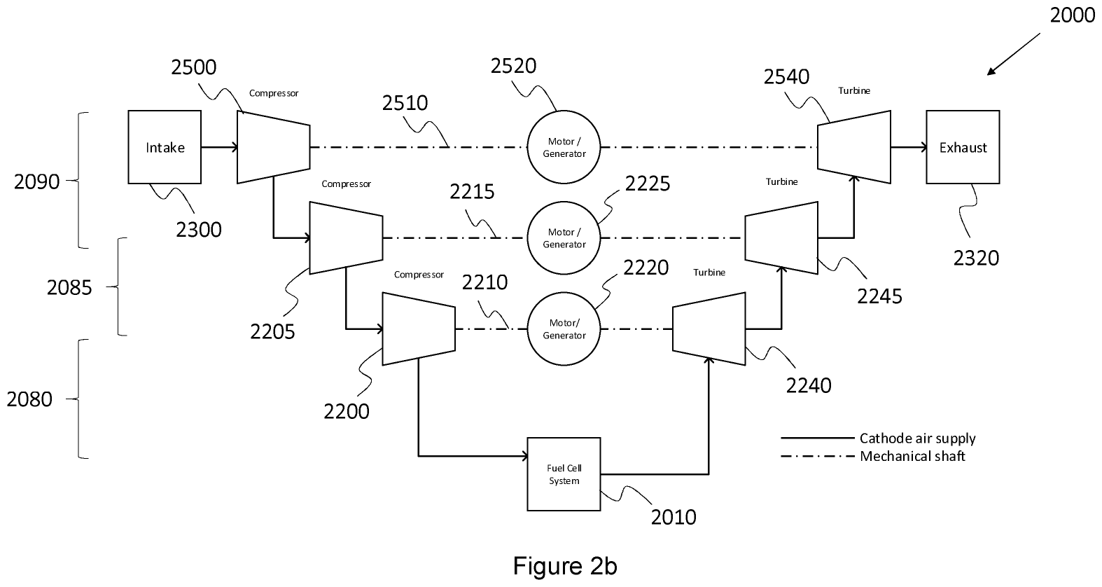

Referring now to FIG. 2a, there is shown a propulsion system 200 similar to the propulsion system 100 of FIG. 1. Reference numerals for similar components of propulsion system 200 will be those as used in FIG. 1 with the numeral increased by 100. For expediency, a full description of similar components may not be provided.

The propulsion system 200 comprises a fuel cell system 201. The fuel cell system 201 may also be referred to as a fuel cell arrangement 201. The fuel cell system 201 would contain the H2 supply 112, the fuel cell stack 110, the water tank 140, water pump 142 and heat exchanger 144 of the water portion 106 from FIG. 1. These features are not shown in detail in FIG. 2a.

The propulsion system 200 comprises an air intake 230 (similar to ECS 130) connected to a first compressor 220. The first compressor 220 is connected to the fuel cell system 201 and a first motor/generator 222. The motor generator 222 is connected to a turbine 224. The arrangement of elements as shown in FIG. 1 is contained in primary portion 208.

The propulsion system 200 further comprises a secondary portion 209. The secondary portion 209 comprises a second compressor 250, a second motor/generator 252 and a second turbine 254. The arrangement shown in FIG. 2a illustrates a switched (switches not shown in FIG. 2a) 2-stage compressor and turbine configuration. By having the optionally used second portion 209, which includes the compressor 250, the motor/generator 252 and turbine 254, the propulsion system 200 can be selectively controlled to provide additional pressures so that the fuel cell system 201 experiences the same absolute pressure irrespective of altitude. In this example, the compressor arrangement comprises two compressors 220, 250 and the turbine arrangement comprises two turbines 224, 254.

An advantageous arrangement is that compressor 250 has a high capacity, such that the compressor 250 can be used up-stream of compressor 220, which would have a lower capacity. The turbines 224, 254 have a similar arrangement, wherein turbine 224 has a lower capacity, and turbine 254 has a higher capacity.

In this arrangement, while the absolute mass flow could be the same through the compressors 220, 250 when connected in series, the corrected mass flow (which makes allowance for the density change when the gas is at a different temperature and pressure) would be higher for compressor 250 and lower for compressor 220.

In an example, the primary portion 208 is operated without the secondary portion 209, this is shown by the dotted line (low pressure ratio, lower mass flow) in FIG. 2a. This operation is particularly beneficial when a low pressure ratio is required, such as at take-off, where the ambient air pressure is high, or where ECS air 230 is used and already pressurised. This operation may also be particularly beneficial where a lower mass flow of reactant is required, either due to the high concentration of oxygen, or due to a lower power being demanded from the fuel cell system 201.

In another example, both the primary portion 208 and the secondary portion 209 are operated. This operation is particularly beneficial at high altitude where the additional compression stage is utilised to achieve a compression level for the fuel provided to the fuel cell stack, so that the fuel cell stack experiences the same pressure as at a lower altitude. Similarly the additional turbine 254 may be activated to recover energy from the exhaust at high altitude.

In yet another example, the secondary portion 209 is operated without the primary portion 208. This is shown in FIG. 2a by the dashed line (low pressure ratio, higher mass flow). This operation may be advantageous in the case that the secondary portion 209 has a higher flow capacity than the primary portion, and the system 200 is required to operate at high power, where a large mass flow of air is needed by the fuel cell stack, but at a low pressure ratio.

FIG. 2a includes a solid line to indicate the operation of the system 200 when there is a high pressure ratio. FIG. 2a includes a dashed line to indicate the operation of the system 200 when there is a low pressure ratio, higher mass flow. FIG. 2a includes a dotted line to indicate the operation of the system 200 when there is a low pressure ratio, lower mass flow. And a dot-dash line to indicate the mechanical shafts between the turbines of the system 200. This style will be used in subsequent figures and noted as such in the figure.

The advantage of selectively using the secondary compressor arrangement means that, when additional compression is required, this can be provided, but when the additional compression is not required, the associated losses from using the secondary portion 209 are not present. As such, the arrangement provides a controllable balance for the output of the propulsion system 200 which, in use, accounts for the losses and provides additional benefits from compression, while avoiding said losses when not in use. Therefore there are no parasitic losses at low altitude, but switching the secondary portion 209 on at higher altitudes enables high pressure ratios, for example between 6 and 9, to be provided to the fuel cell at high altitudes.

The arrangement shown in FIG. 2a is a two-shaft system, one shaft 221 present in the primary portion 208 and one shaft 251 present in the secondary portion 209. Each shaft has a compressor, motor/generator and a turbine. The two shafts 221, 251 may be operated simultaneously or alternatively, as described above, so as to suit the requirements on the propulsion system 200 and the environment in which the propulsion system 200 is located.

The shaft 251 on which the compressor 252, motor/generator 254 and turbine 256 are arranged may be referred to as a “low pressure” shaft, as it can be used when in a low pressure environment to provide the additional compression that may be advantageous in terms of increasing power output from the fuel cell system 201, and the propulsion system 200 as a whole.

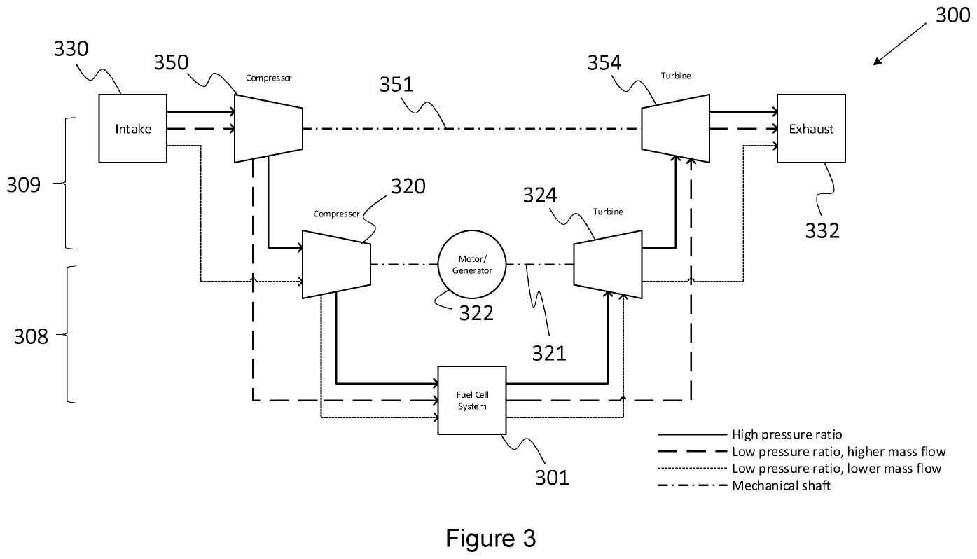

The system 200, both shafts 221, 251 have a motor (each) to drive the shafts 221, 251. This enables a user to change the amount of energy recovery to remove the requirement for the second motor 252. This possibility is explored in FIG. 3 below. FIG. 2b shows a three shaft system 2000.

Referring now to FIG. 2b, there is shown a propulsion system 2000 similar to the propulsion system 200 of FIG. 2a. Reference numerals for similar components of propulsion system 2000 will be those as used in FIG. 2a, with an additional “0”, hence system 2000 of FIG. 2b is similar to system 200 of FIG. 2a. While the example of FIG. 2a shows a 2 shaft system and FIG. 2b shows a 3 shaft system, these are examples and further shafts could be included in systems taught from this disclosure.

In FIG. 2b, alongside the features similar to FIG. 2a, there is a primary portion 2080, a secondary portion 2090 and a third portion 2085, the third portion 2085 being located between the primary portion 2080 and the secondary portion 2090. The third portion 2085 comprises a compressor 2205 connected to both the compressor 2200 of the primary portion 2080 and the compressor 2500 of the secondary portion 2090. The compressor 2205 of the third portion 2085 is arranged on a third shaft 2215 and connected to a motor/generator 2225. The motor/generator 2225 is connected in turn to a turbine 2245. The turbine 2245 of the third portion 2085 is connected to the turbine 2240 of the primary portion 2080 and the turbine 2540 of the secondary portion 2090.

In use, the third shaft may be used in applications above 7500 m altitude. This may be particularly useful when the intake 2300 provides ambient air. Such an arrangement, by enabling use of ambient air at low pressure environments, therefore reduces the need for oxygen air sources or the use of ECS air. In this example, the compressor arrangement comprises three compressors 2200, 2205, 2500 and the turbine arrangement comprises three turbines 2240 2245, 2540. In similar arrangements, not shown, the system may have more than three compressors and/or more than three turbines.

Further systems can be provided using the arrangements herein that use more shafts than the specific examples shown herein. The third shaft 2215 of FIG. 2b may be used at higher altitudes. Further shafts may be used and at correspondingly higher altitudes. Further shafts may be used at increasing altitudes. For examples, further shafts may be included to enable the present system to be used up to and above 15000 m altitude.

Referring now to FIG. 3, there is shown a propulsion system 300 similar to the propulsion system 200 of FIG. 2. Reference numerals for similar components of propulsion system 300 will be those as used in FIG. 2 with the numeral increased by 100. For expediency, a full description of similar components may not be provided.

The propulsion system 300 comprises a fuel cell system 301. The fuel cell system 301 would contain the H2 supply 112, the fuel cell stack 110, the water tank 140, water pump 142 and heat exchanger 144 of the water portion 106 from FIG. 1. These features are not shown in FIG. 3.

The propulsion system 300 comprises an air intake 330 (similar to ECS exhaust air and/or oxygen and/or ambient air supply 130 of FIG. 1) connected to a first compressor 320. The first compressor is connected to the fuel cell system 301 and a first motor/generator 322. The motor/generator 322 is connected to a turbine 324. The arrangement of elements as shown in FIG. 1 is contained in primary portion 308.

As with the secondary portion 209 of FIG. 2a, the arrangement 300 of FIG. 3 has a compressor 350 and a turbine 354 arranged on a secondary shaft 351. In this arrangement, the motor/generator, which is shown in the arrangement of FIG. 2, is not included. The lack of a motor/generator decreases the losses associated with the weight of a motor/generator.

The arrangement 300 may be operated by balancing the turbine work split across the two shafts 321, 351. A further advantage of this arrangement is that the compressor 350 may be driven by the turbine 354, whereby the turbine 354 is driven as a result of the pressure differential between either pressure from the exit of turbine 324 (in the case of the solid line) or the exit pressure of the fuel cell stack in the fuel cell system 301 (in the case of the dashed line), and the exhaust pressure 322. The exhaust pressure 322 is likely to be linked to the ambient pressure.

In this arrangement, the work split may be changed so that the low-pressure turbine 354 provides enough power to drive the low-pressure compressor 350. There is then only a requirement for a motor/generator 322 on the other shaft 321, hence providing the weight saving mentioned above. The shaft 321 can be operated separately from the shaft 351 and therefore, in an example, during take off (at higher ambient air pressure), the shaft 321 with the motor 322 may be used independently of the shaft 351 without a motor. Once the propulsion system 300 is at altitude (at lower ambient air pressure), the second shaft 351 may be used to increase the compression on the fuel provided to the fuel cell system 301.

Furthermore, the shaft 321 and associated compressor 320, motor/generator 322, turbine 324 may be optimised for use at sea level so that the system 300 benefits from the maximum output from that shaft 321 when that shaft 321 is likely to be acting alone (i.e. without the second shaft 351). In this way, the system 300 is more reliable when operating without the benefits from the second shaft 351.

It is possible in the arrangement 300 shown in FIG. 3 to make turbine 324 not do much work, which will leave more energy in exhaust flow. If enough energy is left in the exhaust flow, which can be controlled by a user controlling the behaviour of turbine 324, this excess energy may drive the turbine 354 and subsequently operate compressor 350. This is a particularly energy efficient operating arrangement. This operating arrangement takes advantage of the pressure of effluent exiting the first turbine 324 and the ambient pressure. As such, this operational arrangement is particularly advantageous when system 300 is at altitude. In a method of operation of FIG. 3, turbine 324 is bypassed by the flow so as to leave sufficient energy in the exhaust flow to power turbine 354. In an alternate arrangement of FIG. 3 (not shown), the turbine 324 may be omitted.

As such, we provide in FIG. 3 an arrangement 300 which includes one motor/generator and therefore can provide advantages associated with the omission of one of the motor/generators of FIG. 2a. While in FIG. 3, the motor/generator 252 from FIG. 2a is omitted, in an alternate arrangement, the motor/generator 222 may be omitted and the motor/generator 252 included.

A further advantageous use of the arrangement 300 of FIG. 3 is shown with the dashed line of FIG. 3. In this scenario, when the intake air is at a much higher pressure than the exhaust 332 (for instance if the ECS air, oxygen and/or ambient air 330 from a tank is being used and the system is exhausting to ambient (i.e. low) pressure while at high altitude), the motorised shaft 321 of the primary portion 308 is not required, only the shaft 351 of the secondary portion 309 is required. Such a use of the arrangement 300 can be very energy efficient as a result of reducing parasitic losses to close to zero.

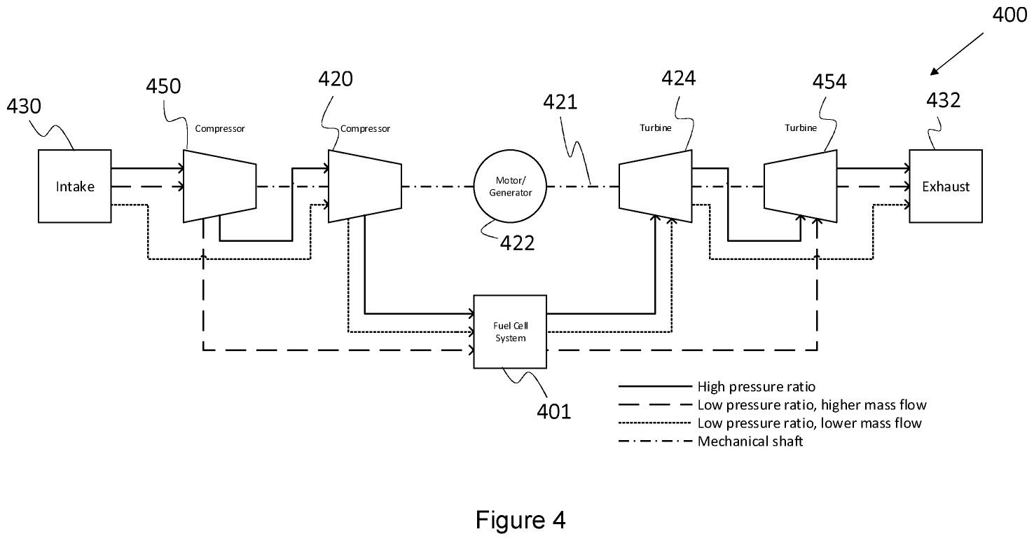

Referring now to FIG. 4, there is shown a propulsion system 400 similar to the propulsion system 300 of FIG. 3. Reference numerals for similar components of propulsion system 400 will be those as used in FIG. 3 with the numeral increased by 100. For expediency, a full description of similar components may not be provided.

The propulsion system 400 comprises a fuel cell system 401. The fuel cell system 401 would contain the H2 supply 112, the fuel cell stack 110, the water tank 140, water pump 142 and heat exchanger 144 of the water portion 106 from FIG. 1. These features are not shown in FIG. 4.

The system 400 differs from those shown in FIGS. 2 and 3 by virtue of the omission of the second shaft 251, 351. In the system 400 shown, there is one shaft 421 on which two compressors 420, 450, a motor/generator 422 and two turbines 424, 454 are arranged.

The propulsion system 400 comprises an air intake 430 (similar to ECS 130) connected to a compressor 450. This compressor 450 is connected to another compressor 420, which is connected to both the fuel cell system 401 and the motor/generator 422. The motor generator 422 is connected to a turbine 424. This turbine 424 is connected to another turbine 454. As with previous Figures, the elements of FIG. 1 are present in this arrangement though not shown for clarity.

The arrangement 400 of FIG. 4, wherein the compressors are arranged on the one shaft advantageously provides a weight saving due to the omission of the second shaft. In the same way, the omission of the second motor/generator (as for FIG. 3) provides a weight saving. In this arrangement 400, both compressors 420, 450 and both turbine stages 424, 454 are powered by the single motor/generator 422.

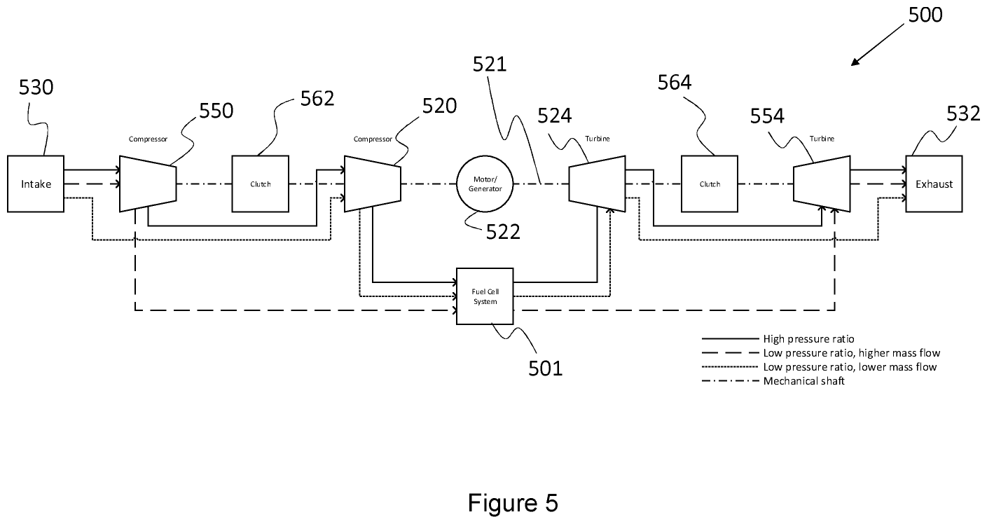

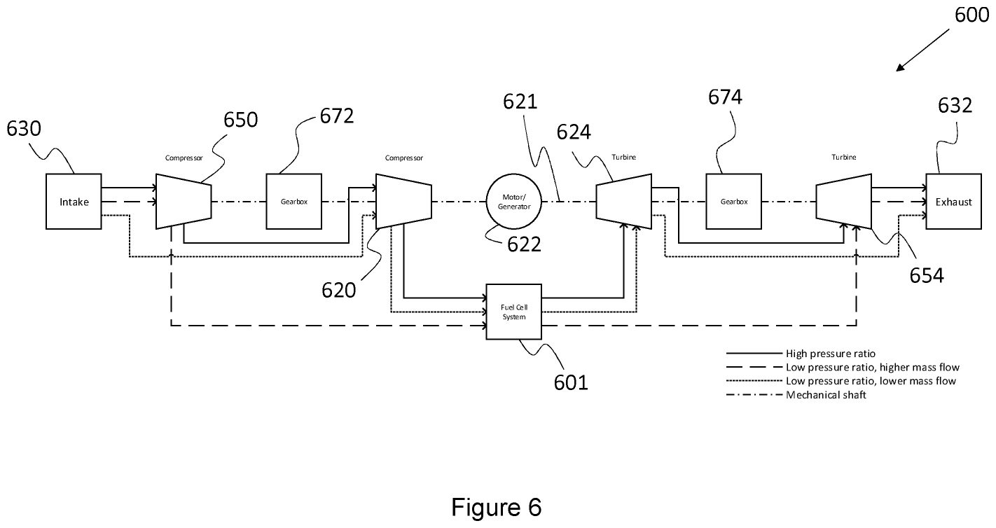

Selection of the size of the compressors 420, 450 may enable a weight saving to be provided over previous arrangements. Furthermore, with reference to the arrangement 200 of FIG. 2a, while the peak power for motor/generator 252 is at a different operating condition than motor/generator 222, both motors/generators 222, 252 will be sized for their respective peak power conditions. However, in the arrangement of FIG. 2a, the pair will not be operated at peak power simultaneously. However, in the arrangement 400 of FIG. 4 (and the arrangements of FIGS. 5 and 6 to be discussed later), the motor/generator 422 can be sized for the overall peak power, which could be less than the sum of the peak power for motor 252 and motor 222.

Referring now to FIG. 5, there is shown a propulsion system 500 similar to the propulsion system 400 of FIG. 4. Reference numerals for similar components of propulsion system 500 will be those as used in FIG. 4 with the numeral increased by 100. For expediency, a full description of similar components may not be provided.

The propulsion system 500 comprises a fuel cell system 501. The fuel cell system 501 would contain the H2 supply 112, the fuel cell stack 110, the water tank 140, water pump 142 and heat exchanger 144 of the water portion 106 from FIG. 1. These features are not shown in FIG. 5.

As with system 400 from FIG. 4, the system 500 differs from those shown in FIGS. 2 and 3 by virtue of the omission of the second shaft 251, 351. In the system 500 shown, there is one shaft 521 on which two compressors 520, 550, a motor/generator 522 and two turbines 524, 554 are arranged.

In addition to the arrangement 400 shown in FIG. 4, the arrangement 500 shown in FIG. 5 has a pair of clutches 562, 564. The first clutch 562 is arranged between the two compressors 520, 550. The second clutch 564 is arranged between the two turbines 524, 554. The clutches 562, 564 may be used so as to de-activate either a compressor or turbine such that the arrangement 500 need not have both the compressors 520, 550 and turbines 524, 554 operating at all points. The clutches 562, 564 may be operated to deactivate the “low pressure” components (compressor 550, turbine 554) when the system 500 is not experiencing low pressure.

Advantageously, therefore, using the arrangement of FIG. 5, the user can deactivate either or both of the compressor 550 and the turbine 554 in circumstances when deactivation is advantageous. This may be in circumstances, as described above, when the arrangement 500 is in sea level (or similar) air pressure such that the fuel cell is experiencing a higher level of pressure than, e.g., during flight. At sea level, there is no requirement of the compressor 550 or turbine 554 to be activated and therefore providing a user with the option of deactivating these components is advantageous and, as a result, provides a more efficient system (by virtue of the removal of activation of unnecessary elements in the arrangement 500).

Referring now to FIG. 6, there is shown a propulsion system 600 similar to the propulsion system 500 of FIG. 5. Reference numerals for similar components of propulsion system 600 will be those as used in FIG. 5 with the numeral increased by 100. For expediency, a full description of similar components may not be provided.

The propulsion system 600 comprises a fuel cell system 601. The fuel cell system 601 would contain the H2 supply 112, the fuel cell stack 110, the water tank 140, water pump 142 and heat exchanger 144 of the water portion 106 from FIG. 1. These features are not shown in FIG. 6.

The arrangement 600 of FIG. 6 has a singular shaft 621 on which the two compressors 620, 650, the motor/generator 622 and the two turbines 624, 654 are arranged. The arrangement 600 of FIG. 6 does not have the clutches 562, 564 of the arrangement 500 of FIG. 5. The arrangement 600 has, instead, a series of gear boxes 672, 674 arranged so as to allow the user to control each component of the arrangement 600 to run at optimal speed. In another arrangement, there is a further gearbox located between the motor/generator 622 and the turbine 624.

The user can controllably operate the components of the arrangement 600 using the gearboxes so as to control the performance of the components of the arrangement 600. While the arrangement 500 of FIG. 5 has two clutches 562, 564, the arrangement 600 of FIG. 6 has three gearboxes 672, 674, 676. While the number is merely an example, there may be any number of clutches or gearboxes (or combinations of the two) in arrangements. The decision lies with the desired outcome, i.e. what operational parameters the user wishes to control and how to control those parameters.

As such, there are arrangements provided wherein performance-controlling elements such as a clutch or a gearbox or the like may be included so as to provide the user with a greater control over the components of the arrangements. The performance-controlling elements may be mechanical or electrical elements that can impact operation of some of the components within the various arrangements shown in examples in the Figures herein. Controlling the operation of such components may allow a user to optimize the operation of the arrangement as a whole to provide efficiency gains (e.g. at low altitude wherein fewer components need to operational) or to provide additional thrust (e.g. at high altitude wherein the additional components may be activated). Controlling the operation of a component may include controlling whether a component is either activated or not activated, or the conditions of operation of that component (e.g. operational speed or the like).

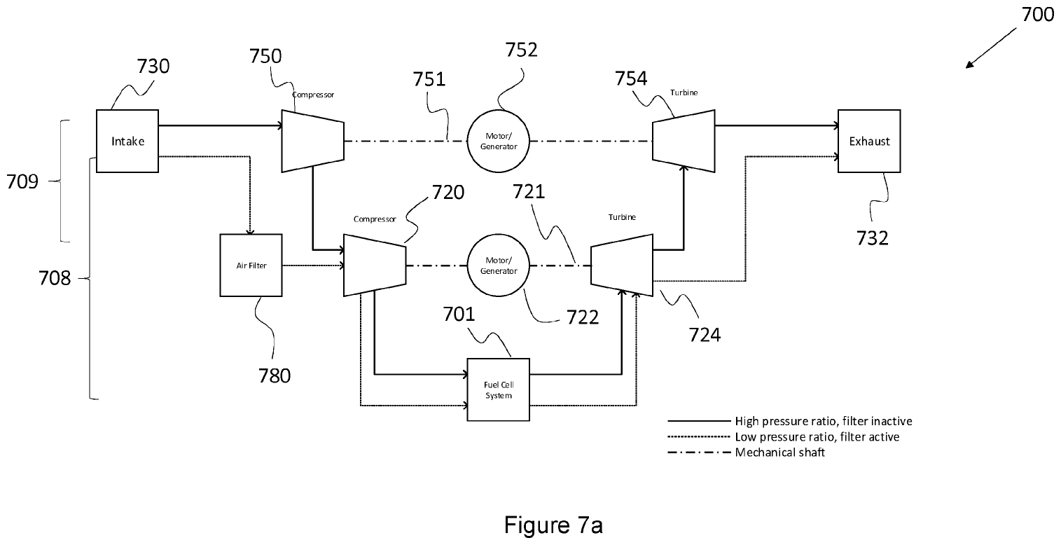

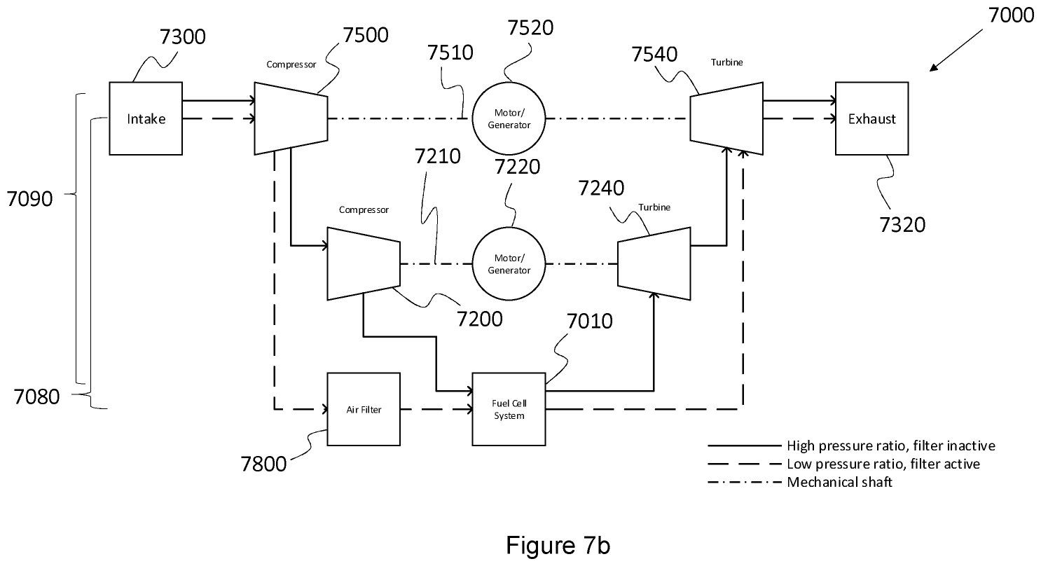

Referring now to FIG. 7a, there is shown a propulsion system 700 similar to the propulsion system 200 of FIG. 2a. Reference numerals for similar components of propulsion system 700 will be those as used in FIG. 2 with the numeral increased by 500. For expediency, a full description of similar components may not be provided.

The propulsion system 700 comprises a fuel cell system 701. The system 700 has two shafts 721 and 751 each with a compressor 720, 750, a motor/generator 722, 752 and a turbine 724, 754. As with the arrangement 200 shown in FIG. 2a, the compressor 720 is connected to both the motor/generator 722 and the fuel cell system 701.

The arrangement 700 shown in FIG. 7a has an air filter 780 arranged between the air intake 730 and the compressor 720. In this arrangement 700, in use the air filter 780 may be switched in and out of activation with the second stage of compression. The user may controllably or selectively pass air through the air filter 780 when desirable. This advantageously may reduce the amount of pollutants that are able to reach the fuel cell system 701. However, across the air filter 780 there will be a pressure loss. As such, there is a balance to make between filtering the air to reduce the amount of pollutants reaching the fuel cell system 701 and increasing the pressure loss through the air filter.

As such, in this arrangement 700, the user may capitalise on switching the gas flow path at sea level compared to that at altitude. In particular, because, at altitude, air is typically cleaner than at sea level. As such, there is a reduced need for filtration at altitude. In this way, this arrangement 700 offers greater control to the user in terms of enabling filtration but bypassing the air filter 780 when operating at altitude. Accordingly, there is both an efficiency gain (in not permanently using the airflow path with the air filter 780) while also providing an improved lifetime gain due to the reduced levels of pollutants reaching the fuel cell system 701.

Referring now to FIG. 7b, there is shown a propulsion system 7000 similar to the propulsion system 700 of FIG. 7a. Reference numerals for similar components of propulsion system 7000 will be those as used in FIG. 7a, with an additional “0”, hence system 7000 of FIG. 7b is similar to system 700 of FIG. 7a.

The air filter 7800 of arrangement 7000 is connected to the compressor 7500 and the fuel cell system 7010, rather than the compressor 720 and the air intake 730 as shown in FIG. 7a. The fuel cell system 7010 of FIG. 7b connects to the compressor 7200, the air filter 7800, the turbine 7240, and the turbine 7540. The high pressure ratio, filter inactive and lower pressure ratio, filter active paths are shown in solid line and dashed line respectively. In such a way, the user can operate the arrangement 7000 of FIG. 7b to use or not use the air filter 7800, as required. This provides a more efficient system, as explained with associated advantages above, which may improve the overall lifetime of the air filter 7800 due to not being in use permanently.

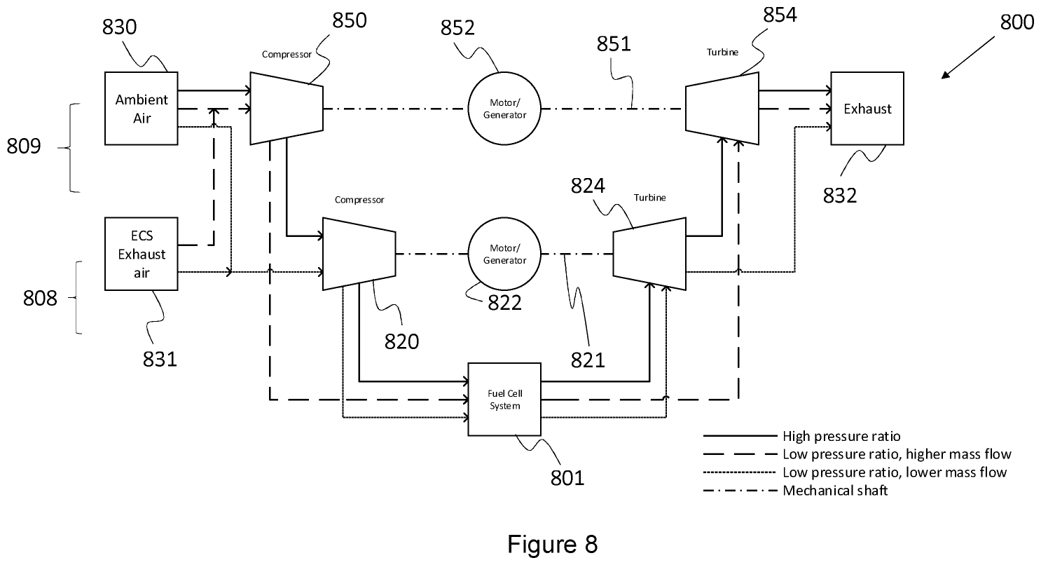

Referring now to FIG. 8, there is shown a propulsion system 800 similar to the propulsion system 700 of FIG. 7a. Reference numerals for similar components of propulsion system 800 will be those as used in FIG. 7a with the numeral increased by 100. For expediency, a full description of similar components may not be provided.

The propulsion system 800 comprises a fuel cell system 801. The system 800 has two shafts 821 and 851 each with a compressor 820, 850, a motor/generator 822, 852 and a turbine 824, 854. As with the arrangement 700 shown in FIG. 7, the compressor 820 is connected to both the motor/generator 822 and the fuel cell system 801.

The arrangement 800 shown in FIG. 8 has both an air intake 830 and an environment control system (ECS) exhaust air source 831. The ECS exhaust air source may have a higher oxygen level than the exhaust air and is therefore particularly advantageous for obtaining power output from the fuel cell system 801.

These sources can be controllably used (in tandem or singularly) to ensure a performance that is desired by the user in the moment. As mentioned, the increased oxygen in the ECS exhaust air may be used during take off to obtain greater power output from the fuel cell than in the case of using the intake source alone. Alternatively, both may be used. Alternatively again, the ECS may be used at altitude to provide a greater amount of pressurised air to the fuel cell system 801 as air at altitude is less dense than that provided by the ECS exhaust air source. In each of these situations, efficiency benefits can be gained from controlling the use of the two air sources 830, 831.

In particular, this arrangement 800 may be particularly advantageous for an APU application. An APU power demand may be low for normal operation at cruise altitude, and therefore the ECS exhaust air from ECS exhaust air source 831 may be sufficient, however occasional, short duration events which demand additional power, may necessitate switching to the ambient air (or enriching the ECS exhaust air, or ambient air, with oxygen). Such short events could include in-flight re-lighting of a conventional gas turbine engine, or anti-icing power when flying through ice-forming conditions. This is such an example of how enabling a user to control the air source for the fuel cell system 801 can be highly beneficial.

Furthermore, switching from ambient air to ECS air (enriched with oxygen or otherwise) may be beneficial when operating in polluted environments. Fuel cell membranes are very sensitive to particulate and chemical pollution. Filters are normally used as protection for the fuel cell membrane. However, if operation is required in an atmosphere with very high pollution (such as a volcanic ash cloud or the like) which could overwhelm the filters, it is advantageous to enable controlled switching from ambient air to an air source which is not from the ambient polluted environment. In such an example, ECS air with enriched oxygen or otherwise could be used.

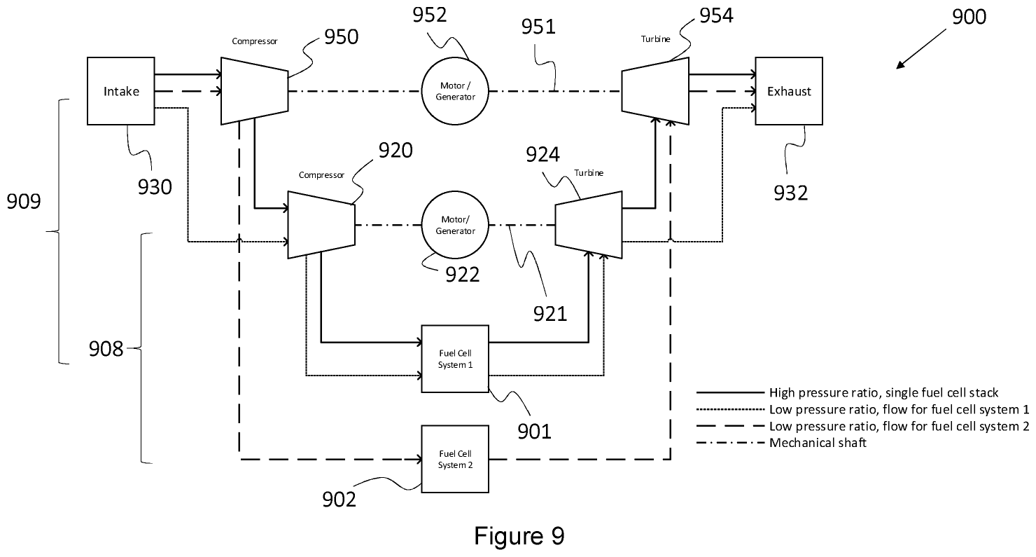

Referring now to FIG. 9, there is shown a propulsion system 900 similar to the propulsion system 800 of FIG. 8. Reference numerals for similar components of propulsion system 900 will be those as used in FIG. 8 with the numeral increased by 100. For expediency, a full description of similar components may not be provided.

The propulsion system 900 comprises a fuel cell system 901. The system 900 has two shafts 921 and 951 each with a compressor 920, 950, a motor/generator 922, 952 and a turbine 924, 954. As with the arrangement 800 shown in FIG. 8, the compressor 920 is connected to both the motor/generator 922 and the fuel cell system 901.

The compressor 950 of the low pressure shaft 951 is connected to both a motor/generator 952 and a booster fuel cell system 902. In this arrangement 900, there are two fuel cell systems 901, 902. Therefore, in use, at take off when greater power is required from the arrangement 900 both fuel cell systems 901, 902 may be operated.

While both fuel cell systems 901, 902 are fed from the intake 930, one may be fed by an ECS source while another may be fed by an air exhaust source. Either may be enriched by an oxygen source as described above for other examples. The fuel cell systems 901, 902 may be controllably operated such that additional power can be provided when required, e.g. during taken off. When such additional power is not required, the additional fuel cell may be deactivated.

Similarly, in the arrangement wherein typically the “low pressure, flow for fuel cell system 2” shaft 951 is not activated, e.g. at sea level wherein air pressure is such that there is no need for the “low pressure” shaft 951, the “low pressure” shaft 951 may be operated to provide additional power for thrust, e.g. during take off. Advantageously this utilises the shaft 951 that would “normally” be used in low pressure, at a higher pressure. This improves efficiency of the arrangement 900 overall as the “low pressure” shaft 951 is not dead weight during take off.

In the arrangement 900, the second fuel cell system 902 may not be operated during cruise, rather the user may run the two compressors 920, 950 in series for cruise power. This arrangement effectively uses balance of plant to generate cruise power and uses the same balance of plant to generate twice the power at sea level, as required during take off and climb conditions. As such, this arrangement 900 is particularly well suited for providing thrust as required by the mechanics inherent in flight.

The sizes of the fuel cell stacks in the fuel cell systems 901, 902 may not be the same. The stacks can be load balanced so as to best provide power for the specific usage of the system 900. For example, if the system 900 is used in an aircraft, one fuel cell system 901 may be smaller than the other fuel cell system 902 (or vice versa). In this way, the system 900 can be arranged to have minimal impact in terms of space required to house the system 900.

The size of the fuel cell stacks in the fuel cell systems 901, 902 may alternatively be quite similar. A benefit of having two fuel cells that are built to near identical specifications, and that can both operate on air, is that the overall development cost including lifetime cost (due to maintenance repair and overhaul) will be reduced. The fuel cell stack lives are approximately 3000 to 20000 hours. If used in an aircraft, the aircraft life may be of the region of 90k-180k hours. As such, a significant number of stack changes (refurbishments or new parts) are required. If two identical stacks are used then these could be used alternately and provide a further function of redundancy, in the event of a failure of one stack in operation or the like.

Due to the short operation of the second stack then the time between overhaul could be nearly doubled if the stacks are used alternatively. Such an approach requires doubling the water and air piping including valving to select the configuration. Further prognostic performance would enable stacks to be used preferentially until both are aged and need replacement.

The additional fuel cell system 902 may not require additional balance of plant, or at least limited additional balance of plant, which, in turn, increases the specific power output. The fuel cell system 902 may be around 50% of the mass of the system 900 this could lead to around a >30% increase in total specific power of system 900 (e.g. for a 1.5 kW/kg base system, approx. 2 kW/kg).

In some Figures an air intake is shown, while in others an ECS exhaust is shown. It is not required that the type of air provision component shown in the examples are strictly adhered to. In that, where a Figure shows an air intake, this may be replaced with an ECS supply and vice versa. The advantages for using ECS air have been previously mentioned and include a lack of need of compression (as the ECS air has already been compressed somewhat) and a higher O2 content. Further, as explained above, any of the sources may be enriched with oxygen.

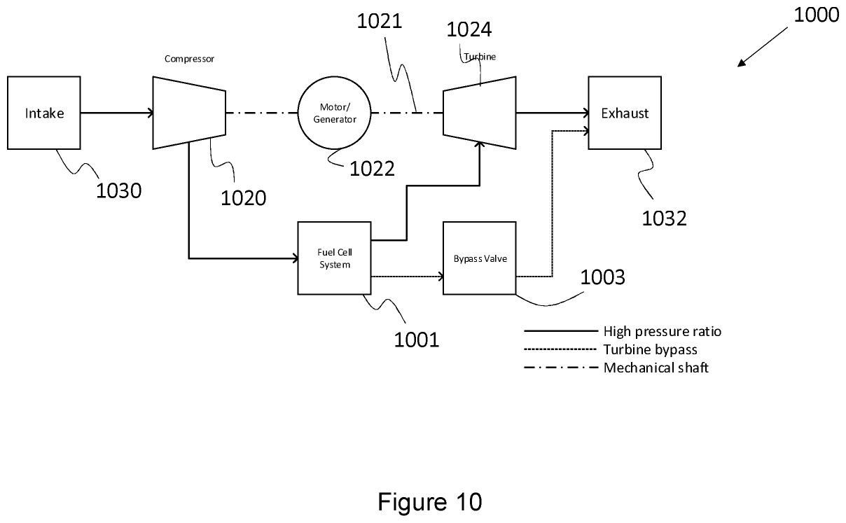

Referring now to FIG. 10, there is shown a propulsion system 1000 similar to the propulsion system 900 of FIG. 9. Reference numerals for similar components of propulsion system 1000 will be those as used in FIG. 9 with the numeral increased by 100. For expediency, a full description of similar components may not be provided.

The propulsion system 1000 comprises a fuel cell system 1001. The system 1000 has one shaft 1021 with a compressor 1020, a motor/generator 1022 and a turbine 1024. As with the arrangement 900 shown in FIG. 9, the compressor 1020 is connected to both the motor/generator 1022 and the fuel cell system 1001.

The arrangement 1000 also includes a bypass valve 1003 connected to the fuel cell system 1001 and the exhaust 1032. The bypass valve 1003 allows the system 1000 to be operated while bypassing the turbine 1024. This may be particularly advantageous in the case of a single shaft system (as shown in the example of FIG. 10) whereby in some modes of operation the compressor 1020 is delivering a high flow than that which the turbine 1024 has capacity for. In such a scenario, a bypass valve 1003 may be useful in protecting the turbine 1034, and operating at a higher flow (and higher fuel cell power) than the turbine has capacity for.

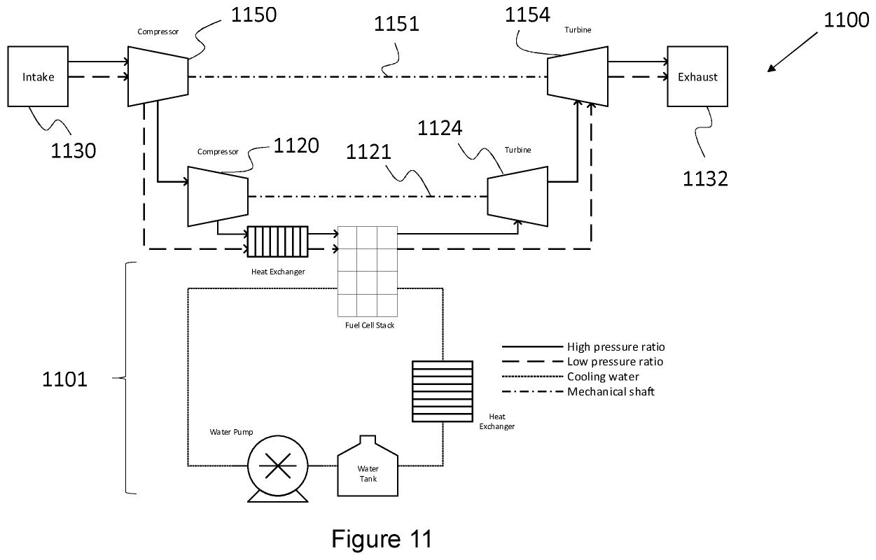

Referring now to FIG. 11, there is shown a propulsion system 1100 similar to the propulsion system 200 of FIG. 2a. Reference numerals for similar components of propulsion system 1100 will be those as used in FIG. 2a with the numeral increased by 900. For expediency, a full description of similar components may not be provided.

The propulsion system 1100 comprises a fuel cell system 1101. In the example shown in FIG. 11, the fuel cell system 1101 shows individual elements of the fuel cell stack, heat exchangers, a water pump and water tank. The system 1100 has two shafts 1121, 1151 each with a compressor 1120, 1150 and a turbine 1124, 1154. As with the arrangement 200 shown in FIG. 2a, the fuel cell system 1101 is connected to both the compressors 1120, 1150 and both the turbines 1124, 1154.

The propulsion system 1100 does not have motors arranged on either of the shafts 1121, 1151. This arrangement may be beneficial in the following scenario. The fuel cell system 1101 may comprise an intermediate or high-temperature proton-exchange membrane (PEM) fuel cell whereby the cathode exit flow is sufficiently high energy (e.g. temperatures above around 120 degrees Celsius) such that the turbines 1124, 1154 may recover sufficient energy from the exit flow to power the compressors 1120, 1150 without a need for the use of motors.

This same usage may be applied to the arrangement 300 of FIG. 3, wherein shaft 351 does not have a motor. The provision is that the fuel cell cathode exit flow is sufficient for turbine 354 to operate and power compressor 350 without a motor. In FIG. 3, however, in the event that the exhaust flow is not as high energy as in the arrangement of FIG. 11, there is a motor 322 to contribute in operating the compressor 320.

These arrangements, and arrangements similar to those shown above, may be extended to re-introduce the electric machines back in, operating as generators, provided the power from the turbines is greater than the power required by the compressors.

Although the fuel cell propulsion systems disclosed have mostly been described in terms of aircraft, other vehicles such as spacecraft and submarines or the like may carry oxygen or liquid oxygen for use in the proposed systems (in place of the air intake or ECS supply). Although, this oxygen or liquid oxygen may be carried primarily for other reasons, integration of additional oxygen for use in the fuel cells of the presently disclosed systems would not be mechanically intensive. Alternatively, or additionally, these vehicles might advantageously be arranged to provide excess oxygen or liquid oxygen to a fuel cell propulsion system as described herein. As such, the disclosed systems would be advantageously provided in such vehicles. Any vehicle which might be propelled by a fuel cell propulsion system such as that described herein would benefit from use of the systems disclosed herein.

The system disclosed herein might be advantageously used to provide propulsion in a vehicle or system which may benefit from a system that can provide a controllably variable amount of propulsion across a wide range of propulsion values.

Numerous advantages are provided by a production of power from fuel cells rather than say via combustion engines. The production of water in place of harmful gaseous emissions (NOx, CO2 etc) has clear associated advantages. Furthermore, operation of the vehicle can occur with significantly reduced noise levels. In a particular example, takeoff and landing phases for aircraft can occur with significantly reduced noise levels due to the lack of high velocity exhaust gas. This may occur due to lower exhaust velocity of the systems described herein.

Provision of additional selectable thrust (by converting the fuel cell electrical power provided by the system described herein into thrust via an electric motor or the like) can also be used by the operator of the vehicle whenever desired. This flexibility would enable a pilot to optimise the thrust choice for the stage of flight or motion (e.g. a race car along a straight). These systems may also not restrict an operator to a particular fuel cell stack if, for example, a change in thrust is desired at any stage in a flight to overcome, or adapt to, changes in flight conditions.

Applications for this system therefore may include automotive, space, domestic or commercial and so forth.

A further benefit of the use of fuel cells over combustion engines as disclosed herein is that microbe colony formation which occurs in existing aircraft kerosene fuel tanks is avoided. The cleaning of such tanks currently requires detergent insecticide cleaners that are somewhat environmentally damaging. In some cases this cleaning may be after each long haul flight. Therefore, the reduction in cleaning has further environmental benefits.

Each of the examples shown and described herein may have a controller or a control unit in the system for enabling a user to controllably activate or de-activate elements within the system. Such a control unit may assist in providing the advantages described in detail above. In an example, the control unit can control the activation or deactivation of the compressors, turbines, motors/generators, the air supply (whether air, ECS or oxygen or a mixture), or any other component. Selective activation of individual components allows a user great control over the overall output of the system.

Disclosed herein is a propulsion system. The propulsion system has a fuel cell system comprising features as shown in previous figures, such as fuel cell stacks. An air supply feeds the fuel cell system. A liquid hydrogen supply may be used to provide liquid hydrogen to the fuel cell system including the fuel cell stack. In an example, not shown, the system may also comprise a helium loop. The helium loop may comprise a helium supply to supply helium and a conduit to hold the helium. The helium loop may be arranged to provide additional cooling for specific portions of the propulsion system. Such portions may include electric energy conducting portions and any motor/generators.

In an example, the liquid hydrogen interacts with helium from the helium supply. The liquid hydrogen may cool the helium and become gaseous hydrogen. The gaseous hydrogen may then be provided into the fuel cell stacks or the like for use in production of electrical energy.

The fuel cell system provides electrical energy in the form of a direct current. The fuel cell system also provides air and water as well as thermal energy in the form of heat. The electrical energy from the fuel cell system may be provided into a network controller. The current may then be provided to any motor and generator arrangements to provide kinetic energy from the electrical energy to a propulsor or the like for providing motion.

The helium in the helium loop is cooled by the liquid hydrogen. The cooled helium can then provide cooling on direct items such as electrical connections providing electrical energy from a network controller to any motor and generator arrangements. The cooled helium can also provide cooling to any motor and generator arrangements themselves. Helium is advantageous in such a system as it has a lower melting point than hydrogen and therefore can be cooled by hydrogen without danger of freezing in the conduits holding the helium. Other cryo coolants may be used, however helium is particularly advantageous.

1. Aircraft propulsion system comprising:
a fuel cell arrangement comprising at least one fuel cell;
an air source for providing air to the fuel cell arrangement;
a compressor arrangement comprising a first compressor in fluid communication with the air source and a fuel cell of the fuel cell arrangement; and,
a turbine arrangement comprising a first turbine mechanically coupled to the first compressor, wherein the first turbine is in fluid communication with the at least one fuel cell,
the system being arranged so that, in use, air from the air source flows in turn to the first compressor, the fuel cell arrangement and the first turbine.

2. An aircraft propulsion system according to claim 1, further comprising
an exhaust for releasing exhaust gases from the aircraft propulsion system, wherein the exhaust is in fluid communication with the first turbine.

3. An aircraft propulsion system according to claim 1, further comprising a first motor or a first generator mechanically coupled to the first compressor and the first turbine.

4. An aircraft propulsion system according to claim 1, wherein
the compressor arrangement further comprises a second compressor, and
the turbine arrangement further comprises a second turbine,
the second compressor is mechanically coupled to the second turbine, and
the second compressor is in fluid communication with the first compressor, and the second turbine is in fluid communication with first turbine.

5. An aircraft propulsion system according to claim 4, further comprising a second motor or a second generator mechanically coupled to the second compressor and the second turbine.

6. An aircraft propulsion system according to claim 4, further comprising a second fuel cell arrangement comprising at least one fuel cell, at least one fuel cell of the second fuel arrangement being in fluid communication with the second compressor and the second turbine.

7. An aircraft propulsion system according to claim 6, wherein the first fuel cell arrangement and the second fuel cell arrangement are optimised for operation at different ambient pressures.

8. An aircraft propulsion system according to claim 4, wherein
the compressor arrangement further comprises a third compressor, and
the turbine arrangement further comprises a third turbine,
the third compressor is mechanically coupled to the third turbine, and
the third compressor is in fluid communication with the first compressor and the second compressor, and
the third turbine is in fluid communication with the first turbine and the second turbine.

9. An aircraft propulsion system according to claim 1, wherein the air source is a source of at least one of ambient air, an environment control system exhaust, and oxygen.

10. An aircraft propulsion system according to claim 1, wherein the mechanical coupling is provided by at least one shaft.

11. An aircraft propulsion system according to claim 1, further comprising at least one of a clutch, a gearbox, an air filter, or a bypass valve.

12. An aircraft propulsion system according to claim 1, further comprising a control system for controlling selective activation of components within the aircraft propulsion system.

13. A method of generating propulsion for an aircraft, comprising:
passing air from an air source to a first compressor;
compressing the air;
passing the compressed air to a fuel cell arrangement comprising at least one fuel cell for generating energy;
passing the fuel cell output air to a first turbine for operating the turbine; and
operating the compressor and turbine, wherein the compressor and turbine are mechanically coupled.

14. A method of generating propulsion for an aircraft according to claim 13, further comprising:
operating a motor or a generator mechanically coupled to the first compressor and the first turbine.

15. The method of claim 13, further comprising:
providing a second compressor and a second turbine, wherein the second compressor and second turbine are mechanically coupled; and
selectively providing air to the second compressor and second turbine.

16. The method of claim 13, further comprising:
providing at least one of a clutch or a bypass valve for selective activation of the first compressor and first turbine or the second compressor and second turbine.

17. The method of claim 13, further comprising:
controllably passing air from the air source to an air filter for filtering the air prior to passing the air to the fuel cell arrangement.

18. The method of claim 14, further comprising:
providing a plurality of fuel cell arrangements,
selectively providing air to the fuel cell arrangements,
wherein the fuel cell arrangements are optimised for operation at different ambient pressures.

19. An auxiliary power unit (APU) for use in an aircraft, the APU comprising:
a fuel cell arrangement comprising at least one fuel cell;
an air source for providing air to the fuel cell arrangement;
a compressor arrangement comprising a first compressor in fluid communication with the air source and a fuel cell of the fuel cell arrangement; and
a turbine arrangement comprising a first turbine mechanically coupled to the first compressor, wherein the first turbine is in fluid communication with the at least one fuel cell,
the system being arranged so that, in use, air from the air source flows in turn to the first compressor, the fuel cell arrangement and the first turbine, and
wherein the air source is selectable from a combination of ambient, environmental control system exhaust or oxygen.
